(19) United States
(12) Patent Application Publication
(10) Pub. No.: US 2026/0065207 A1
(43) Pub. Date: Mar. 5, 2026

(54) System and Method for Aligning Employee Incentives with Project Performance Using Smart Contracts and Distributed Ledger Technology

(71) Applicant: Nicholas Wagter, London (CA)

(72) Inventor: Nicholas Wagter, London (CA)

(21) Appl. No.: 18/816,083

(22) Filed: Aug. 27, 2024

(51) Int. Cl. G06Q 10/0639; G06Q 10/1057

(52) U.S. Cl. CPC G06Q 10/06393; G06Q 10/1057; G06Q 40/0631; G06Q 40/064; G06Q 40/067

(57) ABSTRACT

A computer-implemented system and method for aligning employee incentives with project performance using smart contracts and distributed ledger technology. Employees can stake funds into company projects and receive payouts based on project KPIs. A network of connected computing devices and sensors to monitor project data, which is analyzed to calculate payouts according to the smart contract terms. The system automates the compensation process, provides AI-powered investment tools, real-time dashboards, and enables decentralized governance. By creating direct employee ownership in projects and utilizing transparent, immutable smart contracts, the invention solves the misalignment issues of traditional compensation models. The unique staking mechanism and comprehensive feature set drives employee engagement and accountability, fostering a true sense of ownership in their work.

### BACKGROUND

### Field of the Invention

The present invention relates to the field of employee compensation systems and methods. More specifically, the invention pertains to a computer-implemented system and method for enabling employees to stake funds into company projects and receive payouts based on project key performance indicators (KPIs) using smart contracts and distributed ledger technology.

### Description of the Related Art

Traditional employee compensation models, such as fixed salaries, bonuses, profit-sharing plans or stock options, often fail to optimally align individual employee incentives with the success of specific company projects and innovation goals. Fixed salaries provide little direct motivation for employees to drive the success of particular initiatives. Bonuses and profit-sharing are typically based on overall company or department performance, not individual projects an employee directly contributes to. Stock options only have meaningful value if the company stock price rises, which is impacted by numerous factors beyond any one individual's control or project-level contributions.

This misalignment between an individual's day-to-day effort and eventual rewards can be demotivating and lead to disengagement. Extensive research in organizational psychology and behavioral economics has shown that people are most motivated when there is a clear and direct link between their actions and outcomes ^{1,2}. The absence of project-level incentives and psychological ownership in most traditional compensation models often leads to employees not being fully engaged or feeling a strong sense of personal investment in their work ⁴.

Accordingly, there is a need for an improved employee compensation system and method that better aligns individual incentives with project-level performance using smart contracts and distributed ledger technology. By enabling employees to have a direct financial stake in their project outcomes, providing real-time visibility into project KPIs, and facilitating decentralized governance, such a solution could unlock significant potential for driving organizational performance and innovation.

### SUMMARY

The present invention addresses the need for an improved employee compensation system that better aligns individual incentives with project-level performance. In one aspect, the invention provides a computer-implemented system and method for enabling employees to stake their own funds into company projects and receive payouts based on the project's key performance indicators (KPIs). By leveraging smart contracts and distributed ledger technology, the invention creates a transparent, auditable, and automatically enforced compensation mechanism that directly ties an employee's earnings to their project's performance.

In one embodiment, the system comprises one or more processors, a memory, a network of connected computing devices and sensors, and a distributed ledger. Employees can request to stake a monetary amount into a company project via a user interface, with the request including project parameters that define a smart contract. The system generates a smart contract based on these parameters and stores it on the distributed ledger. The employee's stake amount, project identifier, and other relevant data are recorded in the system's memory.

Advantageously, the invention utilizes a network of connected computing devices and sensors to continuously monitor and transmit the project's KPI data to the system. The one or more processors analyze this data and calculate the employee's payout amount based on their staked funds and the project's performance, as defined in the smart contract. Upon completion, the smart contract is automatically executed to transfer the payout to the employee via a cryptocurrency transaction on the distributed ledger.

The invention further provides features such as AI-powered tools for risk assessment and investment recommendations, real-time dashboards displaying project parameters and alerts, and integration with enterprise management systems. Employees can also participate in decentralized governance by voting on project proposals using token-based mechanisms. Pooled risk funds may be established to mitigate potential losses. The system may also incorporate market data and competitor analysis to provide more contextual performance evaluation.

Additionally, the decentralized nature of the distributed ledger also enables new forms of employee participation and governance in the project selection and management process. Employees can use token-based voting mechanisms to have a say in which projects get funded and how they are run, further enhancing their sense of ownership and alignment with the company's goals.

By enabling direct employee ownership in projects, the present invention solves the problems associated with misaligned incentives in traditional compensation models. Employees are motivated to drive project success, as their payout is directly tied to the project's KPIs. The use of smart contracts and distributed ledgers ensures trust, transparency, and immutability in the compensation process. The invention's unique staking mechanism and comprehensive feature set offers significant advantages over prior art systems by fostering employee engagement, accountability, and a true sense of ownership in their work.

Additional features and advantages of the invention will be set forth in the description which follows., and in part will be obvious from the description, or may be learned by the practice of the invention. These and other features of the present invention will become more fully apparent from the following description, or may be learned by the practice of the invention as set forth hereinafter.

### BRIEF DESCRIPTION OF THE DRAWINGS

The various exemplary embodiments of the present invention, which will become apparent from the proceeds, are described in the following detailed description in conjunction with the accompanying drawings, in which:

FIG. 1 illustrates an example system architecture for implementing the employee project staking and payout functionalities.

FIG. 2A illustrates an embodiment of the employee portal interface that enables employees to view and select company projects to stake funds into.

FIG. 2B illustrates an embodiment of an employer project listing interface that enables employers to create and manage project listings for employees to stake funds into.

FIG. 3 is a flow diagram illustrating an embodiment of an employee's interaction with the system for staking funds into a company project and receiving a payout based on the project's performance.

FIG. 4 is an embodiment of a flow diagram illustrating the system's processing of an employee's stake in a company project and the subsequent payout based on the project's performance.

### DETAILED DESCRIPTION OF THE INVENTION

In the following detailed description of the exemplary embodiments, reference is made to the accompanying drawings, which form a part hereof and show, by way of illustration, specific embodiments in which the invention may be practiced. It is to be understood that other embodiments may be used and structural or logical changes may be made without departing from the scope of the present invention. The following detailed description, therefore, is not to be taken in a limiting sense, and the scope of the present invention is defined by the appended claims.

The following description is provided as an enabling teaching of the present systems, and/or methods in its best, currently known aspect. To this end, those skilled in the relevant art will recognize and appreciate that many changes can be made to the various aspects of the present systems described herein, while still obtaining the beneficial results of the present disclosure. It will also be apparent that some of the desired benefits of the present disclosure can be obtained by selecting some of the features of the present disclosure without utilizing other features.

Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

The terms “a” and “an” and “the” and similar references used in the context of describing a particular embodiment of the present invention (especially in the context of certain claims) are construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein.

All systems described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application. Thus, for example, reference to “an element” can include two or more such elements unless the context indicates otherwise.

As used herein, the terms “optional” or “optionally” mean that the subsequently described event or circumstance can or cannot occur, and that the description includes instances where the event or circumstance occurs and instances where it does not.

The word or as used herein means any one member of a particular list and also includes any combination of members of that list. Further, one should note that conditional language, such as, among others, “can,” “could,” “might”, or “may” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

As used herein, the term “project” refers to a specific undertaking or endeavor by the company with a defined objective. A project may include, but is not limited to: development, production, and/or management of a particular company product, wherein employees working on the product may be able to stake monetary amounts toward that specific product rather than receiving equity in the company as a whole;

an initiative to reduce costs associated with producing a company product or other company expense, wherein employee stakes and payouts are linked to the amount of cost savings achieved;
a marketing campaign or other effort to acquire new customers in a cost-effective manner, wherein employee stakes and payouts are determined based on improvements to customer acquisition costs attributable to the project;
a research and development endeavor to create a new technology or product line, wherein employees who contribute funds to the R&D budget share in the profits generated by the resulting intellectual property or product sales;
a process optimization or automation effort that measurably increases the efficiency and productivity of a company department or function, with employee payouts calculated based on the resulting time and resource savings;
an initiative to expand the company's operations into a new geographic market or industry vertical, with employee stakes acting as a form of internal “crowdfunding” and payouts tied to the success metrics of the expansion;
a philanthropic or social responsibility project that aims to make a positive impact in the community or environment while also generating goodwill and brand value for the company, with participating employees receiving a share of the project's allocated budget upon completion of its objectives; or
a company culture or employee engagement initiative that results in measurable improvements to metrics such as employee satisfaction, retention, or productivity, with employee payouts based on a portion of the estimated financial value of these improvements.
A project has a defined scope and typically a budget, timeline, and deliverables. Projects may be ongoing or have a fixed term.

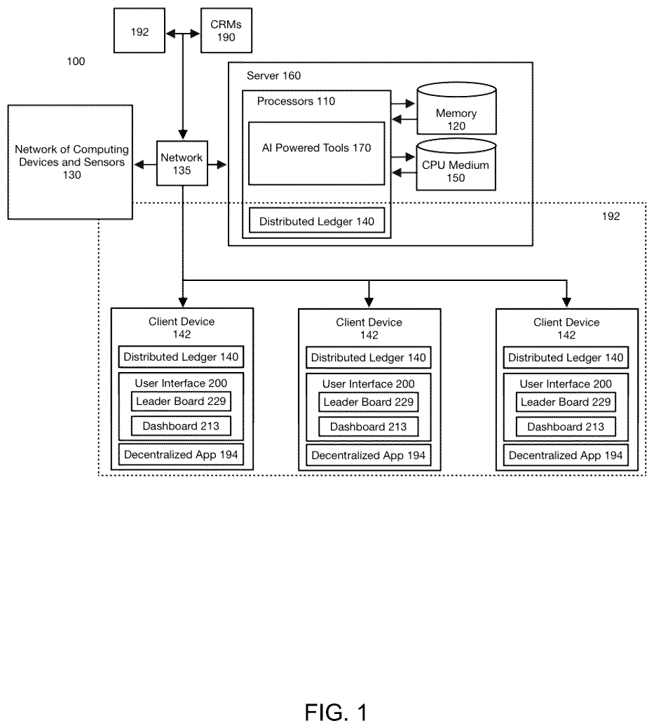

FIG. 1 is a system diagram illustrating the components and interactions of a system 100 for enabling employees to stake funds into company projects and receive payouts based on project key performance indicators. The system 100 includes one or more processors 110, a memory 120 coupled to the one or more processors 110, a network of connected computing devices and sensors 130 coupled to the one or more processors 110 via a wireless communication network 135, a distributed ledger 140 accessible by the one or more processors 110, a non-transitory computer-readable medium 150 storing instructions, and a server 160 hosting the various components.

The one or more processors 110 may be any suitable processing device, such as a central processing unit (CPU), microprocessor, or application-specific integrated circuit (ASIC). The one or more processors 110 execute instructions stored in the memory 120 and the non-transitory computer-readable medium 150 to perform various operations and functions of the system 100. The memory 120 may include volatile memory, such as random access memory (RAM), and/or non-volatile memory, such as read-only memory (ROM) or flash memory.

The computer-readable medium 150 stores information comprising a record of an employee's stake in a project, the employee's identifier, the project identifier, the staked monetary amount, a timestamp, and an associated smart contract.

The network of connected computing devices and sensors 130 are connected to the system 100 via the wireless communication network 135, which may utilize various wireless protocols such as Wi-Fi, Bluetooth, Zigbee, or cellular networks (e.g., 4G, 5G). The data transmitted by the network of connected computing devices and sensors may be secured using encryption methods like AES or RSA, and may be stored in the computer-readable medium 150, or on the distributed ledger 140 for immutability and transparency.

The network of connected computing devices and sensors 130 are configured to monitor KPIs such as revenue and profit data generated by company projects, however, the KPIs are not limited hereto and may be any measurable or non-measurable characteristic, requirement, or metric. The network of connected computing devices and sensors 130 may include but not limited to a wide range of devices, such as smartphones, laptops, tablets, smart watches, cameras, temperature sensors, pressure sensors, accelerometers, gyroscopes, humidity sensors, light sensors, GPS modules, RFID tags, smart meters, industrial control systems, and other connected devices, depending on the specific requirements and nature of the projects being monitored. The data collected by the network of connected computing devices and sensors 130 is transmitted to the one or more processors 110 for analysis and storage in the computer-readable medium 150.

In some embodiments, the network of connected computing devices and sensors 130 further comprises Internet of Things (IoT) devices and sensors configured to collect project-related data. These IoT devices and sensors may include smart cameras, environmental sensors, or industrial control systems that monitor various aspects of a project's progress and performance. The data collected by these devices is transmitted to the one or more processors 110 via the wireless communication network 135. The instructions stored on the computer-readable medium 150 include instructions for receiving the project-related data from the IoT devices and sensors, analyzing the data to generate project performance metrics, and utilizing these metrics in the calculation of the payout amount for the employee. For example, if an IoT sensor detects that a project has achieved a critical milestone ahead of schedule, this information is factored into the payout calculation, potentially increasing the employee's reward for a successful staking decision.

In one embodiment the distributed ledger 140 is a decentralized, shared database that records transactions across a network of computers. The distributed ledger 140 may be implemented using various technologies, such as blockchain, directed acyclic graphs (DAGs), or other distributed ledger technologies. The system 100 interacts with the distributed ledger 140 using APIs and smart contract programming languages such as Solidity or Vyper. Smart contracts, which are self-executing contracts with the terms of the agreement directly written into code, are stored on the distributed ledger 140. The one or more processors 110 can access and execute these smart contracts to facilitate the staking and payout processes.

The non-transitory computer-readable medium 150 stores instructions that, when executed by the one or more processors 110, cause the system 100 to perform various operations. These instructions may be implemented using various programming languages, including but not limited to C++, Java, Python, or Rust. The operations include receiving data indicating an employee's request to stake a monetary amount into a company project, generating a smart contract based on project parameters, storing relevant information in the distributed ledger 140 and the computer-readable medium 150, monitoring project KPIs using the network of connected computing devices and sensors 130, calculating payout amounts using the smart contract, and automatically executing the smart contract to transfer payouts to employees via cryptocurrency transactions on the distributed ledger 140.

Employees access the system 100 through web-based applications hosted on the server 160 using one or more client devices 142, including but not, limited to smartphones, laptops, tablets, or desktop computers. These client devices allow employees to submit staking requests, view project information, and interact with the system's features.

In one embodiment, the server 110 is connected to the one or more client devices 142 via the network 135, which may be a local area network (LAN), wide area network (WAN), or the Internet. The instructions for the web-based applications are stored in the computer-readable medium 150 and executed by the one or more processors 110. The web-based applications enable employee access to the system 100 via an employee portal interface 200 displayed on the client devices 142. The web-based applications may be developed using frameworks such as Angular, React, or Vue.js, and communicate with the one or more processors 110 using APIs and protocols such as HTTP, REST, or GraphQL. In one embodiment the server 160 handles user authentication and authorization, ensuring secure access to the system 100.

In another embodiment, the one or more processors 110 handle the requests from the employee, generate smart contracts, and temporarily store data relevant to current processes and calculations in the memory 120. The network of connected computing devices and sensors 130 continuously monitor project KPIs and transmit data to the one or more processors 110 via the wireless communication network 135. The one or more processors 110 analyze the data, calculate payouts using the smart contracts, and interact with the distributed ledger 140 to execute transactions.

In some embodiments, the instructions stored on the computer-readable medium 150 further comprise instructions for restricting employees to staking funds only into projects in which they are directly involved. The system 100 determines an employee's project involvement based on project assignment data stored in the computer-readable medium 150. When an employee attempts to stake funds into a project, the one or more processors 110 check the project assignment data to verify the employee's involvement. In some embodiments this check is facilitated using the employee's employee ID, which was generated by the company. If the employee ID is not listed on the project the employee is determined to be not directly involved in the project. The staking request is subsequently rejected, and a notification is sent to the employee through the employee portal interface 200.

In other embodiments, the instructions stored on the computer-readable medium 150 allow employees to stake funds into projects in which they are not directly involved, subject to certain conditions. The system 100 limits the monetary amount an employee can stake into projects in which they are not directly involved to a predetermined percentage of the total funds the employee has staked across all projects. For example, if an employee has staked a total of $10,000 across all projects and the predetermined percentage limit is set to 20%, the employee can stake a maximum of $2,000 into projects in which they are not directly involved. Additionally, the system 100 requires employees to stake an amount equal to or greater than the amount staked in projects in which they are not directly involved into at least one project in which they are directly involved. This ensures that employees maintain a significant stake in projects they are actively working on, aligning their interests with the success of those projects.

As shown in FIG. 1, embodiments of the system 100 include leaderboards 229 showcased on the one or more client devices 142 via the employee portal interface 200, wherein the leaderboards 229 showcase top-performing projects and employees with the highest payouts. In one embodiment, the leaderboards 229 may be implemented using web-based technologies including but not limited to HTML, CSS, and JavaScript, and may be updated in real-time as new data is received from the smart contracts and the distributed ledger 140.

In one embodiment the system includes real-time dashboards 213, wherein the dashboards 213 display project KPIs comprising project progress, revenue, and profit metrics, target profit margin, expected return 209, utilization rate, and send notifications and alerts for significant milestones or changes in performance. In another embodiment, the dashboards 213 are built using data visualization libraries such as D3.js or Chart.js, and are accessible through web browsers or mobile applications. The notifications and alerts are sent via email, SMS, or push notifications using protocols such as SMTP or HTTPS.

AI-powered tools 170 configured to analyze project data, provide risk scores 233 or investment recommendations, and automatically rebalance employee portfolios based on predefined risk tolerance levels. In one embodiment, the AI-powered tools 170 utilize machine learning algorithms, such as neural networks or decision trees, to process large amounts of data and generate insights. In another embodiment, these tools are implemented using popular AI frameworks such as TensorFlow or PyTorch.

In one embodiment, the AI-powered tools 170 are implemented using popular deep learning frameworks such as TensorFlow or PyTorch to analyze project financial data, assess risks, provide investment recommendations, and automatically rebalance employee portfolios based on their risk tolerance levels.

According to an embodiment, for financial risk assessment, the AI-powered tools may comprise AI models. These AI models are trained on historical project data including revenue, expenses, profit margins, market conditions, and other relevant features. Techniques like Long Short-Term Memory (LSTM) neural networks, which are well-suited for time series data, are used to predict potential financial risks. In one embodiment, the models are built and trained using the Keras API provided by TensorFlow.

In another embodiment, to generate investment recommendations, the AI system employs collaborative filtering algorithms, similar to those used in recommender systems. PyTorch's TorchRec library provides optimized components for building such recommendation models, which can suggest relevant investment opportunities to employees based on their past investment behavior and portfolio preferences.

For automated portfolio rebalancing, reinforcement learning algorithms like Deep Q-Networks (DQNs) can be applied. In one embodiment, an AI agent can learn an optimal policy to adjust the portfolio allocations based on the employee's predefined risk tolerance and the current market conditions. As such, the agent's actions would involve selling or buying assets to maintain the desired asset mix. PyTorch's reinforcement learning libraries, such as PyTorch DQN, can be leveraged to implement these models.

In some embodiments, the AI-powered tools 170 are integrated into the overall system 100 by exposing REST APIs, which are called by the one or more processors 110 to trigger the AI models' execution. In one embodiment, the input data is fetched from the computer-readable medium 150, the memory 120 or external data sources 192, preprocessed, and fed into the models for inference. The model outputs, such as risk scores 233, investment recommendations, or rebalanced portfolios, are returned via the API and stored back in the computer-readable medium 150. As such, the one or more processors 110 can then use these outputs to generate appropriate notifications, update the real time dashboards 213, or execute the necessary trades through smart contracts on the distributed ledger 140.

In some embodiments the AI models are deployed on cloud platforms like Amazon Web Services ® (AWS), Google Cloud Platform ® (GCP), or Microsoft Azure ®. These platforms provide managed services for running TensorFlow or PyTorch models, such as AWS SageMaker or GCP AI Platform, which can handle the infrastructure complexities and automatically scale the resources based on the incoming requests.

Optionally, the AI models are periodically retrained on the latest data to adapt to changing market dynamics and improve their predictive accuracy. In one embodiment, the training process is automated using CI/CD pipelines and the updated models are seamlessly deployed to production.

Integration with enterprise resource planning (ERP) or customer relationship management (CRM) systems 190 to enrich project data. In one embodiment, the system 100 may connect to external ERP or CRM systems using APIs or middleware solutions to exchange data securely. Common protocols for this integration include REST, SOAP, or GraphQL.

In one embodiment, the system 100 features a decentralized governance model 192, wherein employees can vote on project proposals or changes using token-based voting mechanisms. The governance model 192 is implemented using smart contracts on the distributed ledger 140, with each employee's voting power proportional to their staked funds or tokens. The voting process may be facilitated through a web-based interface or a decentralized application (dApp) 194.

In some embodiments, the decentralized governance model 192 is integrated into the system 100 through smart contracts deployed on the distributed ledger 140. These smart contracts define the voting rules, such as the required quorum, majority thresholds, and the weight of each employee's vote based on their staked tokens. The voting process is conducted through the decentralized application (dApp) 194, which provides a user-friendly interface (not shown) for employees to cast their votes and view the results. The dApp 194 communicates with the smart contracts on the distributed ledger 140 to record the votes and execute the approved proposals or changes.

In another embodiment, the system 100 also includes instructions for providing insurance or pooled risk funds to protect employees from potential losses incurred through their staked funds in company projects. These risk mitigation mechanisms are implemented using smart contracts on the distributed ledger 140. In one embodiment, a portion of each employee's staked funds is automatically allocated to a shared insurance pool. If a project fails or underperforms, resulting in a loss for the staked funds, the affected employees can submit a claim through the dApp 194. The smart contract then verifies the claim and, if approved, releases compensation from the insurance pool to the affected employees based on predefined rules and calculations.

In one embodiment the one or more processors 110 handle the various system requests to generate smart contracts using programming languages such as Solidity or Vyper, and store relevant data in the memory 120 and/or the computer-readable medium 150. In one embodiment, the smart contracts may be deployed on the distributed ledger 140, which could be implemented using blockchain platforms like Ethereum, Hyperledger Fabric, or Corda.

In some embodiments the one or more processors 110 calculate payouts using smart contracts and interact with the distributed ledger 140 to execute transactions. These transactions may involve the transfer of cryptocurrencies or tokens between the system 100 and the employees'digital wallets hosted in the decentralized application 194.

In one embodiment, components, such as leaderboards 229, AI-powered tools 170, and real-time dashboards 213, may be integrated with the core system 100 through APIs and may utilize various data storage solutions like relational databases (e.g., MySQL or PostgreSQL) or NoSQL databases (e.g., MongoDB or Cassandra) to manage and process the data efficiently.

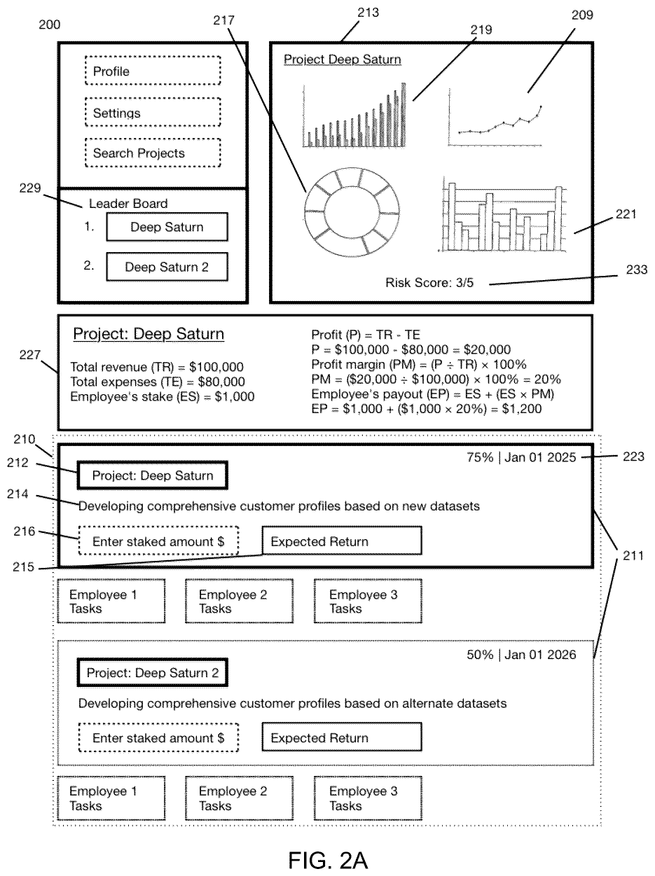

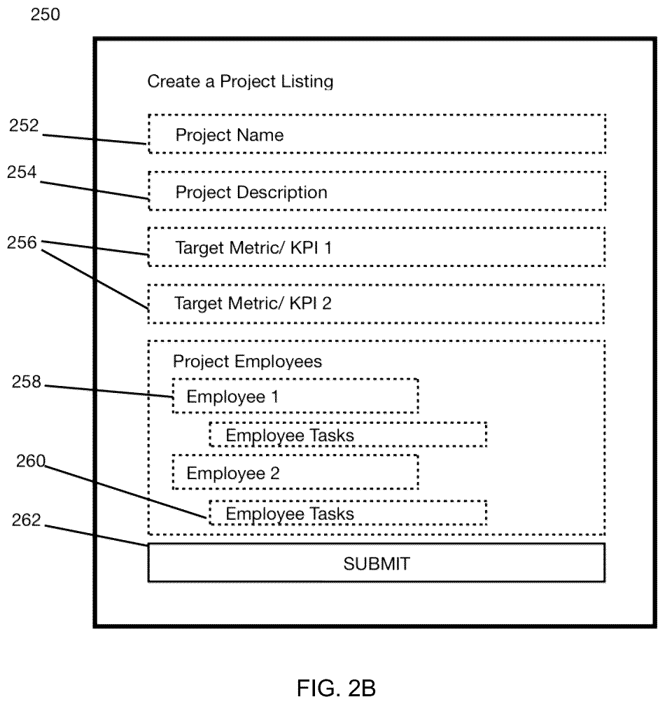

FIG. 2A illustrates an embodiment of an employee portal interface 200 that enables employees to view and select company projects to stake funds into. The interface 200 includes a listing of available projects 210, each with a project name 212, description 214, an input field 216 where the employee can enter a monetary amount they wish to stake into that project, and an expected return where the employee views their expected return 215 based on the staked amount and the associated project parameters. The system 100 retrieves the listing of available projects from a computer-readable medium 150. The employee reviews the different project listings 211 and chooses one to financially back with their own funds. Upon entering a stake amount and confirming, the portal interface 200 submits the employee's stake request to a company server for processing.

In one embodiment, the employee portal interface 200 displays various revenue and profitability metrics on the dashboard 213 for each project listing 211 based on the selected project listing, enabling employees to make informed decisions about which projects to stake their money in. For example, the interface 200 may display each project's target profit margin, a visualization of the expected return 215, and utilization rate (the percentage of employee time that is billable to the project). The interface 200 may also display a total amount of employee funds 217 currently staked in each project, as well as an average stake amount per employee for each project 221. Providing visibility into these metrics 213 can help employees assess each project's financial viability and potential payout size. In another embodiment, the portal interface 200 (not shown) further includes features for employees to sort and filter the list of projects 210 by these different metrics 213.

In one embodiment, the employee portal interface 200 enables employees to monitor progress and payout status of projects they have staked money into via the stake input fields 216. For each staked project, the dashboard 213 may display the project's current completion percentage, expected completion date, and a projected payout amount based on the latest revenue and cost projections. Once a project is completed and paid out, the dashboard displays a breakdown of how the employee's actual payout amount was calculated 227. In some embodiments, the dashboard also allows employees to provide feedback on completed projects and rate their satisfaction with the payout process. This embodiment of the portal interface 200 promotes employee engagement and confidence in the staking system.

In some embodiments, the employee portal interface 200 includes leaderboards 229, wherein the leaderboards 229 showcase top-performing projects and employees with the highest payouts.

FIG. 2B illustrates an embodiment of an employer project listing interface 250 that enables employers to create and manage project listings for employees to stake funds into. The interface 250 includes fields for entering a project name 252, project description 254, target metrics or KPIs 256 such as profit margin and expected return, project employees 258, project employee tasks 260, and a submit button 262 to post the listing to the employee portal interface 200.

The employer project listing interface 250 allows authorized company personnel, such as project managers, to input details about new projects that are open for employee staking. The project name field 252 is where the employer enters a brief title for the project, while the description field 254 allows for a more detailed overview of the project's objectives, timeline, and deliverables.

Importantly, the target metrics fields 256 enable the employer to specify the financial goals and expected outcomes for the project, such as the target profit margin, expected return on investment, and any other relevant KPIs. These metrics are displayed to employees on the project listing 211, on the dashboard metrics 213, and on the employee portal interface 200, providing transparency into the project's anticipated performance and potential payout.

Upon entering all the necessary information and clicking the submit button 262, the project listing 211 is published to the employee portal interface 200, where it is visible to eligible employees for staking. The employer project listing interface 250 may include additional features such as the ability to edit or update existing project listings, set staking limits or deadlines, and track the total amount of employee funds staked in each project.

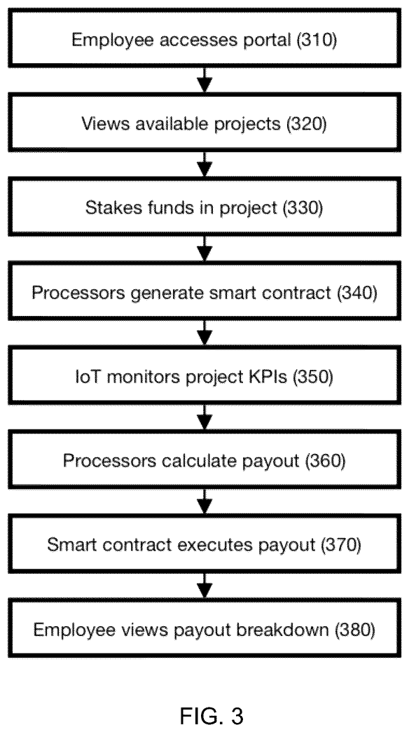

FIG. 3 is a flow diagram illustrating an embodiment of an employee's interaction with the system 100 for staking funds into a company project and receiving a payout based on the project's performance. The process 300 begins at step 310, where an employee, John Smith, accesses the employee portal interface 200 via a web browser on his computer. In one embodiment the server 160 handles the authentication and authorization of John's credentials, ensuring secure access to the system 100.

At step 320, John views the listings of available projects 210 on the employee portal interface 200. Project listings 211 are conditionally displayed to John based on his employee ID number matching one of the employee ID numbers in the project listing 211. In one embodiment each project listing 211 is displayed with its name 212, description 214, an input field 216 for entering a stake amount, and an expected return display view 215 for viewing the expected return based on the associated project parameters and the amount staked by the John. John reads through the project details in the listing 211 and uses the project metrics 213 to assess each project's financial viability and potential payout. In one embodiment the project metrics 213 are displayed based on the project listing 211 selected by John.

As shown in FIG. 2A, John decides to stake $1,000 into Project Alpha, which has KPIs comprising expected revenue of $100,000, expected expenses of $80,000, a target profit margin of 20%, and an expected ROI of 20%. At step 330, John enters his stake amount of $1,000 into the input field 216 for Project Alpha. The expected return is automatically displayed to John. John reviews the expected return and confirms his selection by pressing Enter on his client device 142. The employee portal interface 200 submits John's stake request to the one or more processors 110 for processing.

At step 340, the one or more processors 110 receive John's stake request from the employee portal interface 200. The one or more processors 110 generate a smart contract based on the project parameters, including the project identifier, John's employee ID, the staked amount of $1,000, and the current timestamp. The one or more processors 110 store the smart contract and associated information in the computer-readable medium 150 and on the distributed ledger 140.

Over the course of Project Alpha's implementation, the network of connected computing devices and sensors 130 continuously monitor the project's KPIs, such as revenue and profit data, at step 350. The network of connected computing devices and sensors 130 transmit this data to the one or more processors 110 for analysis and storage in the computer-readable medium 150 and/or the distributed ledger 140.

Upon completion of Project Alpha, Project Alpha is sold for $100,000. The one or more processors 110 calculate the payout amount for John's stake using the smart contract and the project's final financial data which is stored in the computer-readable medium 150 and on the distributed ledger 140 at step 360. Project Alpha generated total revenue of $100,000 and incurred expenses of $80,000, resulting in a profit of $20,000 and a profit margin of 20%. Based on John's $1,000 stake and the project's 20% profit margin, the one or more processors 110 calculate John's payout to be $1,200 (i.e., his original $1,000 stake plus a 20% return of $200).

At step 370, the one or more processors 110 execute the smart contract on the distributed ledger 140, automatically transferring the calculated payout amount of $1,200 to John's wallet which in this embodiment is a cryptocurrency wallet. The one or more processors 110 also update the project's status and John's staking history on the distributed ledger 140 and the computer-readable medium 150.

Finally, at step 380, John visits his personalized dashboard on the employee portal interface 200 to view the completed Project Alpha and his staking payout. In one embodiment the employee portal interface 200 displays a breakdown of how John's $1,200 payout was calculated 227, including Project Alpha's final revenue, expenses, profit, and profit margin. In some embodiments, John can provide feedback on his staking experience and rate his satisfaction with the payout process using the employee portal interface 200. The process 300 concludes with John receiving his staking payout and having full visibility into the project's financial performance.

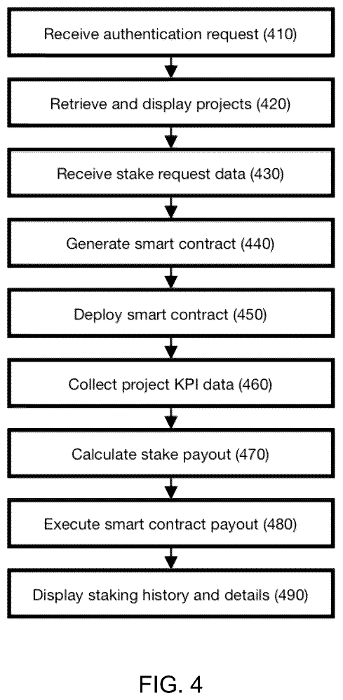

FIG. 4 is a flow diagram illustrating an embodiment of the system's processing of an employee's stake in a company project and the subsequent payout based on the project's performance, following the user flow described in FIG. 3. The process 400 begins at step 410, where the server 160 receives an HTTP request from the employee portal interface 200, containing the employee's authentication credentials. The server 160 verifies the employee's credentials against the user database stored in the computer-readable medium 150 and grants access to the system 100 if the credentials are valid.

At step 420, the server 160 retrieves the list of available projects 210 based on his employee ID from the computer-readable medium 150 and sends this data to the employee portal interface 200 for display. In some embodiments the server 160 also retrieves KPIs, such as revenue and profitability data, from the network of connected computing devices and sensors 130 and/or the computer-readable medium 150, via the one or more processors 110, and includes this information in the data sent to the employee portal interface 200. In another embodiment the KPIs and other project data collected by the network of connected computing devices and sensors 130 is stored on the distributed ledger 140 providing further clarity and security to the data flow architecture.

In one embodiment, when the employee John Smith, submits his stake request for Project Alpha through the employee portal interface 200, (step 430), the server 160 receives the request containing John's employee ID, the project identifier for Project Alpha, the staked amount of $1,000, and a timestamp at step 430. The server 160 forwards this stake request data to the one or more processors 110 for further handling.

At step 440, the one or more processors 110 generate a smart contract using the stake request data received from the server 160 with reference to the current embodiment. In some embodiments the smart contract includes the project identifier, John's employee ID, the staked amount of $1,000, and the timestamp. In another embodiment the one or more processors 110 store the smart contract and its associated data in the distributed ledger 140 and/or the computer-readable medium 150 for record-keeping and future reference.

The one or more processors 110 then deploy the smart contract onto the distributed ledger 140 at step 450. The distributed ledger 140, being a decentralized and immutable storage system, ensures the integrity and security of the smart contract and its associated stake data. The smart contract is now ready to monitor the performance of Project Alpha and calculate payouts based on the project's financial metrics.

Throughout the duration of Project Alpha, the network of connected computing devices and sensors 130 continuously collect data on the project's KPIs, such as revenue and expenses, at step 460. In this embodiment the network of connected computing devices and sensors 130 transmit this data to the one or more processors 110 for analysis and storage in the computer-readable medium and/or the distributed ledger 140. The one or more processors 110 aggregate and process the data to calculate real-time metrics, such as profit margins and ROI, which are used to update the project's status and financial performance on the employee portal interface 200.

In one embodiment, when Project Alpha concludes, the one or more processors 110 retrieve the project's data from the computer-readable medium 150 and/or the distributed ledger 140 and use it to calculate the payout for John's stake at step 470. Using the data collected by the network of connected computing devices and sensors 130, the one or more processors 110 determine that Project Alpha generated a total revenue of $100,000, incurred expenses of $80,000, and achieved a profit margin of 20%. Based on the smart contract's terms and John's $1,000 stake, the one or more processors 110 calculate a payout of $1,200 for John, representing his original stake plus a 20% return.

At step 480, the one or more processors 110 execute the smart contract on the distributed ledger 140, triggering the automatic transfer of the calculated payout amount of $1,200 to John's cryptocurrency wallet hosted by the decentralized application 192. In one embodiment the one or more processors 110 update the smart contract's state on the distributed ledger 140 to reflect the completed payout and store a record of the transaction on the computer-readable medium.

Finally, at step 490, the server 160 retrieves John's staking history and the details of the completed Project Alpha from the memory 120. In some embodiments the server 160 sends this data to the employee portal interface 200, where it is displayed on John's employee portal interface 200. The employee portal interface 200 provides a detailed breakdown of Project Alpha's financial performance and how John's payout was calculated, promoting transparency and trust in the staking process. The server 160 also updates the leaderboards 229 based on John's successful stake in Project Alpha.

The process 400 demonstrates the seamless interaction between the various components of the system 100, including the server 160, processor 110, memory 120, network of connected computing devices and sensors 130, and distributed ledger 140, to facilitate the employee staking and payout process. The use of smart contracts and decentralized storage ensures the security, transparency, and automation of the system, while the real-time data collection and analysis provide employees with up-to-date information on project performance and their potential payouts.

In one embodiment, following the process described in FIG. 3 and FIG. 4, the instructions stored on the computer-readable medium 150 for receiving data indicating an employee's request to stake a monetary amount into a company project further comprises instructions for allowing employees to stake a combination of monetary amounts and company-specific tokens or rewards. These company-specific tokens or rewards may be earned by employees through various means, such as achieving performance milestones, participating in training programs, or contributing to company initiatives. The system 100 maintains a record of each employee's token balance in the computer-readable medium 150. When an employee submits a staking request through the employee portal interface 200, they can specify the desired allocation of monetary funds and company-specific tokens. The one or more processors 110 then validate the request, ensuring that the employee has sufficient funds and tokens available, and create a smart contract on the distributed ledger 140 that reflects the staked allocation.

Furthermore, building upon the process outlined in FIG. 3 and FIG. 4, in some embodiments the instructions stored on the computer-readable medium 150 enable employees to adjust their stake allocations over time based on project performance. The real-time dashboards 213 provide employees with up-to-date information on project KPIs, such as revenue, profit margins, and target achievement percentages. If an employee determines that a project is underperforming or overperforming relative to their expectations, they can submit a request through the employee portal interface 200 to modify their stake allocation. The one or more processors 110 then validate the request and update the corresponding smart contract on the distributed ledger 140 to reflect the new allocation.

This flexibility allows employees to actively manage their staked funds and tokens, potentially mitigating risks or capitalizing on opportunities as projects progress. The AI-powered tools 170 can also assist employees in making informed decisions about their stake allocations by providing risk scores 233, investment recommendations, and portfolio rebalancing suggestions based on the employee's risk tolerance and the project's performance data.

### EXAMPLE

In an embodiment of a real-life implementation of the system 100, ABC Company, a large multinational corporation, adopts the employee staking platform to engage their workforce in the company's growth and success. The company sets up the system 100, including the one or more processors 110, memory 120, network of connected computing devices and sensors 130, distributed ledger 140, non-transitory computer-readable medium 150, and server 160, as described in FIG. 1.

ABC Company's management team identifies a new project, “Project Gamma,” which aims to develop and launch a new mobile application for their e-commerce division. The project requires a total investment of $500,000 and offers employees multiple investment options with different time frames and potential payoffs. For a 1-year investment, the expected revenue is $1,500,000 with a target profit margin of 25% and an expected ROI of 35%. For a 2-year investment, the projected revenue is $3,000,000 with a target profit margin of 30% and an expected ROI of 45%. Finally, for a 3-year investment, the estimated revenue is $5,000,000 with a target profit margin of 35% and an expected ROI of 55%.

In this embodiment the project also offers different payout structures based on the parameters defined in the smart contract. Employees can choose between a fixed percentage payout of 10% of their initial investment, a tiered reward system where payouts increase based on the project's performance (e.g., 10% for meeting the target ROI, 15% for exceeding the target by 10%, and 20% for exceeding the target by 20% or more), or a profit-sharing model where employees receive a portion of the project's profits proportional to their investment.

The AI-powered tools 170 analyze the project data, incorporating market data, industry benchmarks, and competitor analysis to provide context for Project Gamma's performance. The tools leverage machine learning algorithms to identify patterns and predict future project outcomes. Additionally, the system 100 connects with ABC Company's enterprise resource planning (ERP) and customer relationship management (CRM) systems to enrich the project data, providing a more comprehensive view of the project's potential outcomes.

Based on the analysis and Sarah Johnson's predefined risk tolerance level, the AI-powered tools 170 recommend the 1-year investment option with a tiered reward payout structure. The project details, including the name, description, target metrics, investment requirements, payout structures, AI-generated risk scores, recommendations, and relevant market and competitor insights, are uploaded to the system 100 and stored in the computer-readable medium.

Sarah Johnson, a software engineer at ABC Company, logs into the employee portal interface 200 using her credentials. The server 160 authenticates Sarah's credentials and grants her access to the system 100. Sarah navigates through the available projects and decides to stake $5,000 of her personal funds into Project Gamma.

Sarah enters her stake amount of $5,000 into the input field 216 for Project Gamma on the employee portal interface 200 and confirms her selection. With reference to the current embodiment, the employee portal interface 200 submits Sarah's stake request to the one or more processors 110, which generate a smart contract based on the project parameters, Sarah's employee ID, the staked amount, and the current timestamp. The one or more processors 110 store the smart contract in the computer-readable medium 150 and deploy it onto the distributed ledger 140.

As Project Gamma progresses, the network of connected computing devices and sensors 130 collect real-time data on various project KPIs. For example, the network of connected computing devices and sensors 130 monitor the number of user registrations, daily active users, average transaction value, and user retention rate of the mobile application. The network of connected computing devices and sensors 130 also tracks the project's expenses, such as employee salaries, marketing costs, and infrastructure expenses. This data is transmitted to the one or more processors 110 for analysis and storage in the computer-readable medium 150 and/or the distributed ledger 140.

The one or more processors 110 use the collected data to calculate and update Project Gamma's revenue, profit, and ROI metrics in real-time. These metrics are displayed on the real-time dashboards 213, accessible to both the management team and the employees who have staked their funds in the project. The employee portal interface 200 also sends notifications and alerts to stakeholders when significant milestones are achieved or if there are any critical changes in the project's performance.

In some embodiments to further enhance the accuracy and fairness of the payout calculations, the one or more processors 110 retrieve market data, industry benchmarks, and competitor analysis from external data sources. This data may include average revenue growth rates, profit margins, and ROI figures for similar projects or companies within the same industry. The retrieved data is then incorporated into the smart contract's payout calculation logic, allowing for normalization and adjustment of the project's performance relative to market conditions and industry standards.

For example, if the average profit margin for similar projects in the market is 25%, and Project Gamma achieves a 33.33% profit margin, the smart contract may apply a multiplier or bonus to the payout amounts to reward the project's outperformance. Conversely, if Project Gamma's profit margin falls below the industry benchmark, the smart contract may adjust the payouts downward to reflect the underperformance. By incorporating external data into the payout calculations, the system ensures that the rewards are not only based on the project's absolute performance but also take into account its relative success compared to the wider market.

Upon the 1-year mark from the beginning of Project Gamma, the mobile application is launched, and the project generates a total revenue of $1,800,000 with expenses amounting to $1,200,000. The one or more processors 110 calculate the final profit margin to be 33.33%, and the actual ROI stands at 50%. Using these figures and the smart contract associated with Sarah's stake, the one or more processors 110 determine her payout to be $6,666.67 (her original $5,000 stake plus a 33.33% return of $1,666.67). The one or more processors 110 then execute the smart contract on the distributed ledger 140, automatically transferring $6,666.67 to Sarah's cryptocurrency wallet. The transaction is recorded on the distributed ledger 140, ensuring transparency and immutability. Sarah can view the details of her payout, including the breakdown of Project Gamma's financial performance 227, on her employee portal interface 200.

The embodiments described herein are given for the purpose of facilitating the understanding of the present invention and are not intended to limit the interpretation of the present invention. The respective elements and their arrangements, materials, conditions, shapes, sizes, or the like of the embodiment are not limited to the illustrated examples but may be appropriately changed. Further, the constituents described in the embodiment may be partially replaced or combined together.

What is claimed is:

1. A system for enabling employees to stake funds into company projects and receive payouts based on project Key Performance Indicators (KPIs), the system comprising:
a. one or more processors;
b. a memory coupled to the processor;
c. a network of connected computing devices and sensors coupled to the processor;
d. a distributed ledger accessible by the one or more processors; and
e. a non-transitory computer-readable medium storing instructions that, when executed by the one or more processors, enable the system to perform operations comprising:
i. receiving data indicating an employee's request to stake a monetary amount into a company project, wherein the request comprises project parameters defining a smart contract;
ii. generating the smart contract based on the received data, wherein the smart contract is stored on the distributed ledger;
iii. storing, in the non-transitory computer-readable medium, information comprising a record of the employee's stake in the project, the employee's identifier, the project identifier, the staked monetary amount, a timestamp, and the associated smart contract;
iv. monitoring KPIs generated by the project over a period of time using the network of connected computing devices and sensors;
v. calculating a payout amount for the employee based on the monitored KPIs data and the staked monetary amount using the smart contract; and
vi. automatically executing the smart contract to transfer the calculated payout amount to the employee via a cryptocurrency transaction on the distributed ledger.

2. The system of claim 1, wherein the instructions stored on the computer-readable medium further comprise instructions for generating leaderboards showcasing top-performing projects and employees with the highest payouts.

3. The system of claim 1, wherein the instructions stored on the computer-readable medium further comprise instructions for implementing AI-powered tools to analyze project data and provide employees with project risk scores or investment recommendations, and automatically rebalancing employee portfolios based on predefined risk tolerance levels.

4. The system of claim 1, wherein the instructions stored on the computer-readable medium further comprise instructions for displaying real-time dashboards with KPIs comprising project progress, revenue, and profit metrics, and facilitating notifications and alerts for significant project milestones or changes in performance.

5. The system of claim 1, wherein the instructions stored on the computer-readable medium further comprise instructions for allowing employees to stake a combination of monetary amounts and company-specific tokens or rewards, and enabling employees to adjust their stake allocations over time based on project performance.

6. The system of claim 1, wherein the instructions stored on the computer-readable medium further comprise instructions for offering different payout structures, such as fixed percentages, tiered rewards, or profit-sharing models, based on the project parameters defined in the smart contract.

7. The system of claim 1, wherein the instructions stored on the computer-readable medium further comprise instructions for incorporating market data, industry benchmarks, or competitor analysis to provide context for project performance.

8. The system of claim 1, further comprising instructions for implementing a decentralized governance model configured to enabled employees to vote on project proposals or changes using token-based voting mechanisms to ensure proportional representation in decision-making processes.

9. The system of claim 8, further comprising instructions for establishing guidelines and protocols for dispute resolution and smart contract modifications within the decentralized governance model.

10. The system of claim 1, further comprising instructions for providing insurance or pooled risk funds to protect employees from potential losses incurred through their staked funds in company projects.

11. The system of claim 1, wherein the instructions stored on the computer-readable medium further comprises instructions for restricting employees to staking funds only into projects in which they are directly involved, as determined by project assignment data stored in the computer-readable medium.

12. The system of claim 1, wherein the instructions stored on the computer-readable medium further comprise instructions for:
a. allowing employees to stake funds into projects in which they are not directly involved;
b. limiting the monetary amount an employee can stake into projects in which they are not directly involved to a predetermined percentage of the total funds the employee has staked across all projects; and
c. requiring employees to stake an amount equal to or greater than the amount staked in projects in which they are not directly involved into at least one project in which they are directly involved.

13. The system of claim 1, wherein the network of connected computing devices and sensors further comprises Internet of Things (IoT) devices and sensors configured to collect project-related data, and wherein the instructions stored on the computer-readable medium further comprise instructions for:
a. receiving project-related data from the IoT devices and sensors;
b. analyzing the received project-related data to generate project performance metrics; and
c. utilizing the generated project performance metrics in the calculation of the payout amount for the employee.

14. The system of claim 1, wherein the instructions stored on the computer-readable medium further comprise instructions for:
a. storing all system data on the distributed ledger, comprising: employee data, such as employee identifiers, staking history, and payout records; project data, such as project identifiers, project parameters, and project performance metrics; smart contract data, including the code, execution history, and associated transactions; connected device and sensor data, such as IoT device identifiers, collected project-related data, and generated insights; governance data, including voting records, proposals, and resolved disputes; financial data, such as employee stake allocations, project funding, and payout distributions; and risk management data, including insurance policies, pooled risk funds, and claims history;
b. ensuring data immutability, transparency, and security by via the inherent properties of the distributed ledger;
c. enabling decentralized data access and sharing among authorized parties within the system; and
d. d. facilitating auditing and regulatory compliance by maintaining a tamper-proof record of all system activities and transactions on the distributed ledger.

15. A computer-implemented method for enabling employees to stake funds into company projects and receive payouts based on project Key Performance Indicators (KPIs), the method comprising:
a. receiving, by one or more processors, data indicating an employee's request to stake a monetary amount into a company project, wherein the request comprises project parameters defining a smart contract;
b. generating, by the one or more processors, the smart contract based on the project parameters, wherein the smart contract is stored on a distributed ledger;
c. storing, in a non-transitory computer-readable medium, information comprising a record of the employee's stake in the project, the employee's identifier, the project identifier, the staked monetary amount, a timestamp, and the associated smart contract;
d. monitoring, by the one or more processors, KPI data generated by the project over a period of time using a network of connected computing devices and sensors devices and sensors;
e. calculating, by the one or more processors, a payout amount for the employee based on the monitored KPI data and the staked monetary amount using the smart contract; and
f. automatically executing, by the one or more processors, the smart contract to transfer the calculated payout amount to the employee via a cryptocurrency transaction on the distributed ledger.

16. The method of claim 15, further comprising:
analyzing, by the one or more processors, project data using artificial intelligence to generate risk scores or investment recommendations; and
providing the risk scores or investment recommendations to employees via a user interface.

17. The method of claim 15, further comprising:
displaying real-time dashboards on a user interface, wherein the dashboards present project progress, revenue, and profit metrics; and
generate notifications and alerts for significant project milestones or changes in performance.

18. The method of claim 15, further comprising:
retrieving, by the processor, market data, industry benchmarks, or competitor analysis from external data sources; and
incorporating the retrieved data into the calculation of the payout amount using the smart contract.

19. The method of claim 15, further comprising:
implementing a decentralized governance model, wherein employees can vote on project proposals or changes using token-based voting mechanisms; and
executing, by the processor, the proposed changes to the project or smart contract based on the voting results.

20. The method of claim 15, further comprising:
establishing, by the processor, a pooled risk fund using a portion of the staked monetary amounts from employees; and
allocating, by the processor, a portion of the pooled risk fund to compensate employees for losses incurred due to project performance, wherein the allocation is determined by the smart contract.
